(19) United States
(12) Patent Application Publication
(10) Pub. No.: US 2008/0082247 A1
(43) Pub. Date: Apr. 3, 2008

(54) ENGINE START/STOP CONTROL FOR MULTIPLE ENGINE OHV BASED ON OPERATING STATISTICS

(75) Inventors: William Charles Hawkins, Mt. Vernon, IL (US); Sean James McManus, Calgary (CA)

Correspondence Address: SENNIGER POWERS LLP, ONE METROPOLITAN SQUARE, 16TH FLOOR, ST LOUIS, MO, 63102, US

(73) Assignee: NATIONAL RAILWAY EQUIPMENT CO., Mt. Vernon, IL (US)

(21) Appl. No.: 11/469,312

(22) Filed: Aug. 31, 2006

(51) Int. Cl. G06G 7/70; G06F 19/00

(52) U.S. Cl. 701/101

(57) ABSTRACT

Operation of a second or additional engine is initiated based on operating statistics. A second or additional engine is stopped based on operating statistics.

### FIELD OF THE INVENTION

The present invention generally relates to the control and operation of multiple sources of power and, in particular, to systems and methods of starting and stopping engines of a locomotive.

### BACKGROUND OF THE INVENTION

Off highway vehicles, such as locomotives, which have multiple engines implement various scenarios for selectively operating the engines. For example, some locomotive control scenarios simultaneously operate all engines at all times.

There is a need for more efficient scenarios for starting a second or additional engine after one or more engines are already operating. There is also a need for efficient scenarios for stopping operation of additional engines. Alternatively, and in addition, there is also a need for efficient scenarios for stopping operation of a primary engine. Alternatively, and in addition, there is also a need for efficient scenarios for controlling engine idle in a single or multiple engine system.

These scenarios should take into account the delivery of power in response to operator demand, the cost of fuel, various ways to efficiently use engine fuel and efficiently operate engines, and the cost of engine maintenance and repair.

### SUMMARY OF THE INVENTION

In one embodiment, operation of a second or additional engine is initiated based on operating statistics. In another embodiment, a second or additional engine is stopped based on operating statistics.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other objects and features will be in part apparent and in part pointed out hereinafter.

### BRIEF DESCRIPTION OF THE DRAWINGS

FIG. 1 is a block diagram of one embodiment of an off highway vehicle of the invention.

FIG. 2 is a block diagram of one embodiment of part of the electrical system of an off highway vehicle of the invention.

FIG. 3 is a flow chart illustrating one embodiment of the invention for starting an additional engine.

FIG. 4 is a flow chart illustrating one embodiment of the invention for stopping an additional engine.

Corresponding reference characters indicate corresponding parts throughout the drawings.

### DETAILED DESCRIPTION

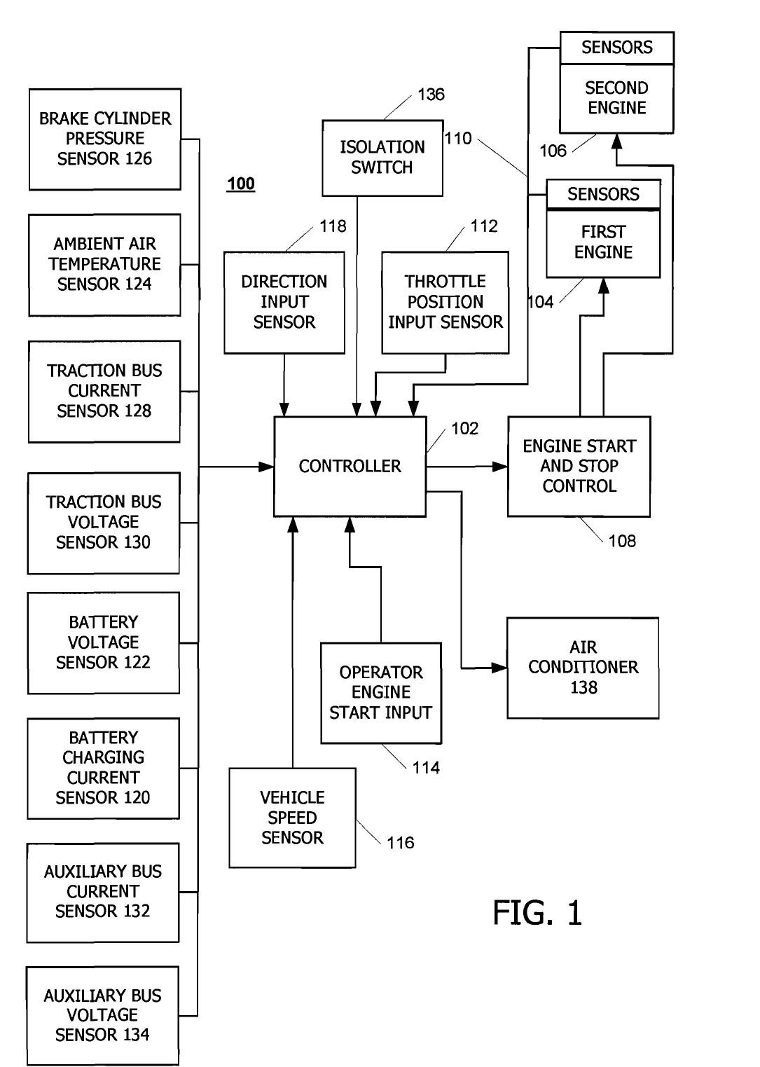

As shown in FIG. 1, an off-highway vehicle 100 has a plurality of engines which are operating in response to a controller 102. FIG. 1 illustrates the vehicle 100 with two engines, a first engine 104 and a second engine 106. However, it is contemplated that the vehicle 100 may have two or more engines and FIG. 1 includes only two engines for simplicity. Vehicle 100 also includes an engine start and stop control 108 which interfaces with the controller 102 and is linked to the engines 104, 106 to initiate their operation and to terminate their operation. The engine start and stop control 108 independently controls each of the engines 104, 106. Line 110 illustrates a link between sensors of each of the engines 104, 106 and the controller. In particular, link 110 between sensors of the engines and the controller 102 provides information to the controller regarding the status and/or operation of each of the engines (e.g., various parameters of the engines such as rpms, operating power output, temperature and other engine operating parameters).

In one embodiment, the engines 104, 106 are operated in response to a throttle position or rpm setting input sensor 112 which indicates the position of the throttle as controlled by the operator. In addition, there may be an optional operator engine start input 114 where the operator can directly or indirectly instruct the controller 102 (e.g., via a keypad) with regard to operation of the engines or termination of operation of the engines. In addition, a vehicle speed sensor 116 for indicating vehicle speed and/or a direction input sensor 118 for indicating desired direction of movement of the vehicle 100 may provide information to the controller 102.

In an embodiment when the first and second engines are not operating, the controller 102 will initiate operation of the first engine 104 when the throttle position or rpm setting input sensor 112 indicates that the throttle has been moved by the operator from one position (e.g., an idle position) to a position which requires additional power. For example, off-highway vehicles frequently have throttles with a notch positions idle, and 1-9 and controller 102 would initiate operation of the first engine 104 by signaling the engine start and stop control 108 when the throttle position or rpm setting sensor 112 senses movement of the throttle from position idle to position 1. As described herein, embodiment of the invention will be presented with reference to throttle notch positions. However, it is contemplated that any type of throttle configuration may be used in combination with embodiments of the invention.

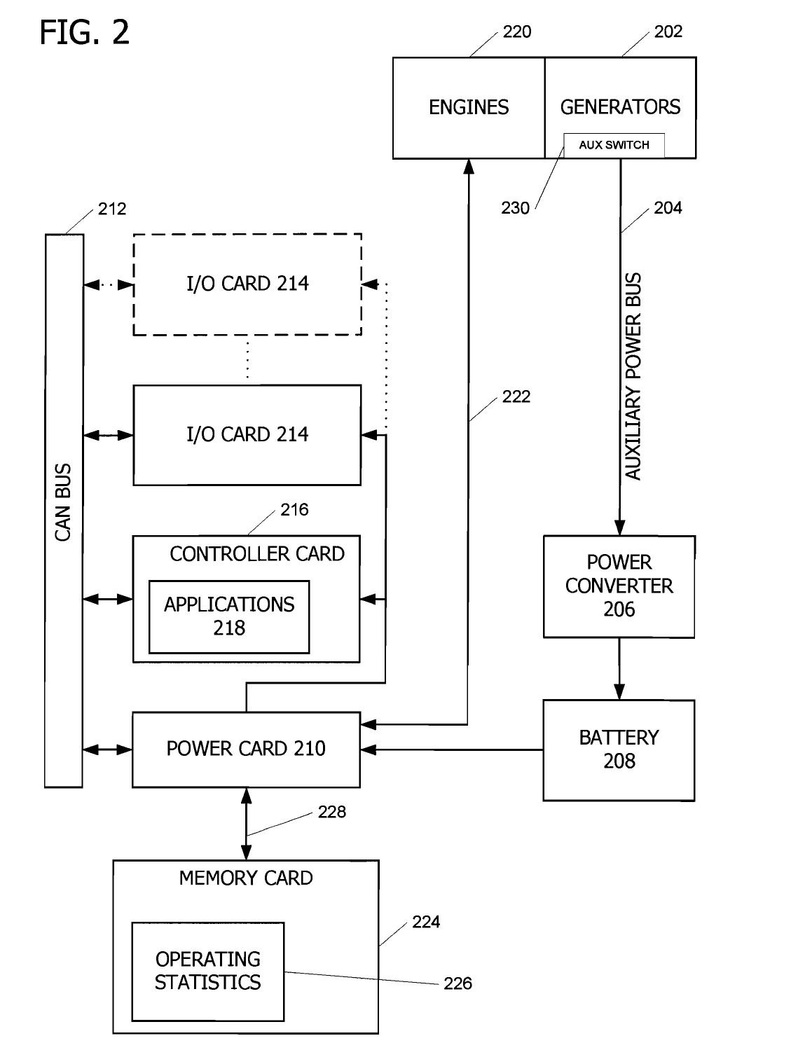

In an embodiment when the first engine 104 of the off-highway vehicle 100 is operating and the second engine 106 is not operating, the operation of the second engine will be initiated by the controller 102 via engine control 108 when a set of operating conditions with regard to the first engine are met. As illustrated in FIG. 2, these conditions include at least one of the following: (1) the throttle position or rpm setting as indicated by sensor 112, (2) a vehicle speed as indicated by sensor 116 and/or (3) an operating output of the first engine as indicated by the first engine sensors via line 110.

In particular, a flow chart illustrated in FIG. 2 indicates one embodiment of the operation of the controller 102. In general, it is contemplated that the controller may be any programmable device such as a processor or programmable logic controller (PLC). The controller 102 monitors operation of the first and second engines via 110.

In one embodiment, an output level of the first engine 104 may be indicated to the controller 102 by a brake output, such as indicated by a traction bus current sensor 128, a traction bus voltage sensor 130, an auxiliary bus current sensor 132 and an auxiliary bus voltage sensor 134, the corresponding sum of these sensors being indicative of the total output of the first engine 106 when the second engine 104 is not operating. Also, an isolation switch 136 which an operator may use to control the status of the vehicle 100 interfaces with the controller 102 to indicate vehicle status. In addition, the controller 102 may be responsive to the isolation switch 136 and control the vehicle in response thereto.

Referring to FIG. 2, a block diagram of one embodiment of part of the electrical system of an off highway vehicle of the invention is illustrated. One or more generators 202 power an auxiliary power bus 204 which supplies ac power to a power converter 206. The converter 206 converts the ac to dc to charge a battery 208. A power card 210 which supplies stepped down power to various components and cards of the system is energized by the battery. As used herein, a card refers to a printed circuit board or other modular circuit which is part of the vehicle electronics. The power card 210 also interfaces with various components or other cards. For example, the power card 210 interfaces with the controls for the engines 220 via a bus 222 (e.g., SAE J1939).

A controller area network (CAN) 212 links a plurality of input/output (I/O) cards 214 and a controller card 216, each of which is powered by the power card 210. The I/O cards 214 interface with various systems of the vehicles, such as the air conditioner 138. The controller card 216 includes a processor or programmable logic controller (e.g., controller 102 which executes various applications 218 (instructions such as software) to control operation of the vehicle.

In one embodiment, the controller 216 includes a memory for storing the various operating statistics of each of the engines 220 of the vehicle 100. In another embodiment, a separate memory card 224 stores the operating statistics 226 and interfaces with the controller card 216 via the power card 210 and a bus 228 (such as an SPI bus). In one embodiment, it is contemplated that the memory card 224 would be connected to the power card 210 by a harness. One advantage to this configuration is that the memory card 224 is separate from the power card 210 and the controller card 216 so that replacing either of these cards does not require replacement of the memory card 224. As a result, the memory card 224, which maintains the operating statistics of the vehicle 100, remains with the vehicle even when the controller card 216 and/or the power card 210 is replaced or upgraded.

### Starting Engine with Least Usage

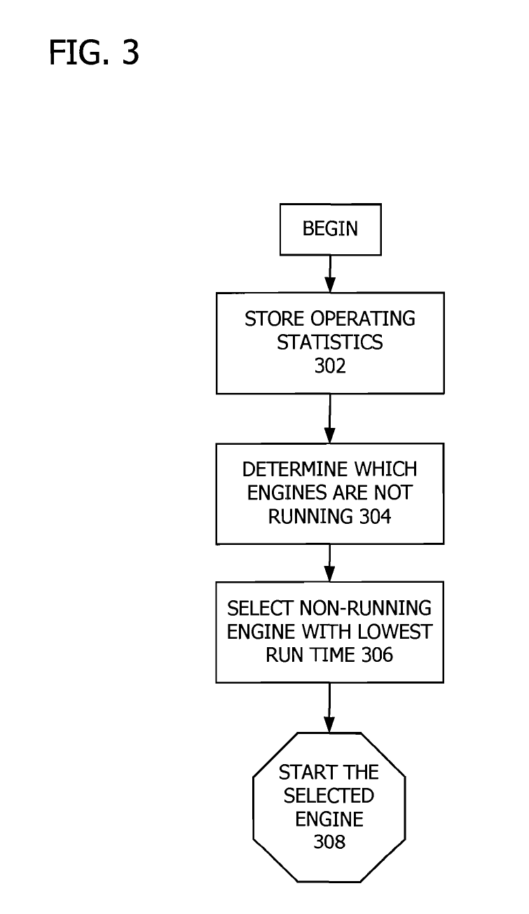

Referring to FIG. 3, in one embodiment, the controller 102 controls the operation of the vehicle 100 and, in particular, determines which engine 220 to start. For example, in a two (2) engine vehicle 100 when both engines are not operating or in a three or more engine vehicle 100 when at least two engines are not operating, the controller would determine which engine 220 should be started. Initially, the controller stores at 302 the operating statistics 226 for each engine of the plurality of engines 220 of the vehicle in the memory card 224. When there is a need to start an additional engine, the controller determines at 304 which of the plurality of engines 220 are not running. Thereafter, at 306 the controller 102 selects an engine of the plurality of engines 220 that is not running as a function of the operating statistics stored in the memory 224. In one embodiment, the least used engine is selected for operation and the controller 102 at 308 starts the selected engine.

It is contemplated that any operating statistic or a combination of operating statistics, either weighted or as raw data, may be evaluated by the controller 102 to determine which of the non-running engines should be started next. For example, if the operating statistics 226 stored in the memory 224 comprise the total run time of each of the plurality of engines, the controller 102 may be programmed to select the engine of plurality of engines that is not running and has the lowest total run time.

For example, the following one or more operating statistics may be stored in the memory and used by the controller 102 to select a particular engine to start:
a) miles traveled in forward by the off-highway vehicle (as indicated by the vehicle speed sensor 116 and the direction input sensor 118);
b) miles traveled in reverse by the off-highway vehicle (as indicated by the vehicle speed sensor 116 and the direction input sensor 118);
c) miles traveled in neutral by the off-highway vehicle (as indicated by the vehicle speed sensor 116 and the direction input sensor 118);
d) kilowatt hours used for motive force by the off-highway vehicle (as indicated by the current and voltage sensors 128-134 and the direction input sensor 118);
e) total kilowatt hours produced by the off-highway vehicle (as indicated by the current and voltage sensors 128-134);
f) maximum power developed in highest throttle position or rpm setting by the off-highway vehicle (as indicated by the current and voltage sensors 128-134 and by the throttle position input sensor 112);
g) minimum power developed in highest throttle position or rpm setting by the locomotive (as indicated by the current and voltage sensors 128-134 and by the throttle position input sensor 112);
h) hours and minutes that all engines of the locomotive were shut down (as indicated by engine start/stop control 108 and the engine sensors);
i) hours and minutes that the locomotive has spent isolated (as indicated by isolation switch 136);
j) total hours and minutes each engine has been shut down (as indicated by engine start/stop control 108 and the engine sensors);
k) total hours and minutes each engine has been running (as indicated by engine start/stop control 108 and the engine sensors);
l) hours and minutes each engine spent idling while the locomotive was parked (as indicated by engine start/stop control 108, the engine sensors and the throttle position sensor 112);
m) hours and minutes each engine spent idling while the locomotive is setup in a direction and on-line (as indicated by engine start/stop control 108, the engine sensors, the throttle position sensor 112 and isolation switch 136);
n) hours and minutes each engine (and/or the vehicle) spent in each throttle position or rpm setting (as indicated by throttle sensor 112);
o) hours and minutes that the locomotive was unable to shutdown all of the engines due to a directional input being set to forward (as indicated by engine sensors, throttle sensor 112 and direction sensor 118);
p) hours and minutes that the locomotive was unable to shutdown all of the engines due to a directional input being set to reverse (as indicated by engine sensors, throttle sensor 112 and direction sensor 118);
q) hours and minutes that the locomotive was unable to shutdown all of the engines due to vehicle speed (as indicated by engine sensors and vehicle speed sensor 116);
r) hours and minutes that the locomotive was unable to shutdown all of the engines due to battery charging current being greater than a predetermined battery charging current (as indicated by engine sensors and battery charging current sensor 120);
s) hours and minutes that the locomotive was unable to shutdown all of the engines due to battery voltage being below a predetermined battery voltage (as indicated by engine sensors and battery voltage sensor 122);
t) hours and minutes that the locomotive was unable to shutdown all of the engines due to ambient air temperature being too low (as indicated by engine sensors and ambient air temperature sensor 124);
u) number of times that the locomotive has started an engine due to a directional input being set to forward (as indicated by engine sensors and direction sensor 118);
v) number of times that the locomotive has started an engine due to a directional input being set to reverse (as indicated by engine sensors and direction sensor 118);
w) number of times that the locomotive has started an engine due to a brake cylinder pressure being below a predetermined brake cylinder pressure (as indicated by engine sensors and brake cylinder pressure sensor 126));
x) number of times that the locomotive has started an engine due to a battery voltage being below a predetermined battery voltage (as indicated by engine sensors and battery voltage sensor 122);
y) number of times that the locomotive has started an engine due to vehicle speed (as indicated by engine sensors and vehicle speed sensor 116);
z) weighted average of the run time of each engine (as indicated by engine sensors and engine start/stop control 108;
aa) total revolutions of each engine (as indicated by the engine sensors);
bb) estimated total revolutions of each engine (as indicated by engine sensors or based on other sensors; and
cc) hours and minutes the compressor is pumping (as indicated by the air conditioner 138).

In general, any one or more of the operating statistics noted above, or any others known to those skilled in the art may be stored in the memory 224 and used by the controller 102 to determine which engine to start.

In one embodiment, the controller 102 selects which engine to start as a function of the total hours and minutes each engine has been running. That is, the controller 102 selects the engine having that has been running for the lowest total of hours and minutes to be started.

In another embodiment, the controller uses a weighted average of the run time of each engine to determine which engine to select for starting. The weighted average corresponds to wear on an engine. An engine running at idle experiences less stress and wear than when running at its full rated output. Therefore, the amount of time that an engine is running at its full rated output has more influence on engine wear than the amount of time that the engine is running at idle. Accordingly, when determining which engine has less wear, the amount of time that an engine has been operated at each output level should be weighted differently. A weighted average for use with this embodiment may be calculated by, for example, multiplying the time at idle by 1, multiplying the time at 1300 rpm by 2, multiplying the time at 1500 rpm by 3, multiplying the time at 1800 rpm by 4, and totaling these products. This total for each engine may or may not be divided. The controller 102 selects the engine with the lowest weighted average for starting.

In one embodiment, if a particular generator is driving the auxiliary power bus 204, it may be preferable to first select the engine driving the particular generator so that auxiliary power will be available. Alternatively, an optional auxiliary switch 230 may be controlled, such as via bus 222, to associate an auxiliary power bus 204 with the particular generator and its engine.

### Shutting Down Engine with Most Usage

In addition, in one embodiment, the controller 102 may determine which of the plurality of engines are running and select for shut down an engine of the plurality of engines as a function of the operating statistics 226 stored in the memory 224. In this embodiment, the engine with the most usage based on the operating statistics may be shutdown first. For example, the operating statistics stored in the memory may include the total run time of each of the plurality of engines and the controller 102 may be programmed to select the engine of plurality of engines that are running and has the highest total run time.

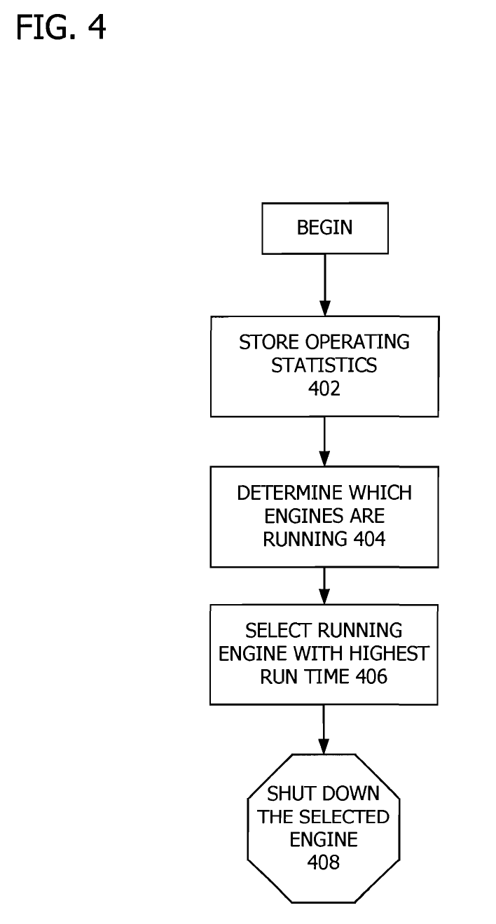

Thus, in one embodiment, as shown in FIG. 4, the controller of an off-highway vehicle having a plurality of running engines stores at 402 in a memory operating statistics for each engine, determines which of the plurality of engines are running, selects at 406 a running engine as a function of the operating statistics stored in the memory; and shuts down at 408 the selected engine. For example, the engine have the highest total run time of the running engines may be shut down when one of the plurality of engines is no longer needed.

In another embodiment where a selected engine is driving the generator driving the auxiliary power bus, the controller 102 may control switch 230 to switch the auxiliary power bus to a different generator driven by different engine so that the selected engine can be shut down.

In some configurations with three (3) or more engines, one of the engines may be a primary engine which drives the auxiliary power bus generator and the remaining engines are secondary engines. In these configurations, the primary engine would be started first and stopped last. As a result, the controller would select an engine of the secondary engines for starting or stopping as a function of operating statistics stored in the memory. For example, the secondary engine having the highest operating time could be selected for shut down when one of the plurality of engines is no longer needed.

In general, any one or more of the operating statistics noted above, or any others known to those skilled in the art may be stored in the memory 224 and used by the controller 102 to determine which engine to shut down.

### Separate Memory Saving Operating Statistics

As noted above, in one embodiment it is contemplated that the memory 224 be separate from controller, power card and/or other components and removable separately from the other components. Thus, for example, the controller, power card and/or other components can be replaced without replacing the memory. As a result, the memory continues to be associated with the off-highway vehicle and maintains cumulative operating statistics of the off-highway vehicle independent of changes to the controller 216, applications 218 and/or any other components.

In one example, the controller is part of a controller card and the memory comprises a memory card separate from the controller card. Optionally, the controller card and the memory card may communicate via a controller area network bus 212 and/or the power card 210.

In an embodiment, the auxiliary bus receives power from an operating engine and provides power to auxiliary systems of the off-highway vehicle. The switch 230 may be a switch matrix controlled by the controller for selectively connecting the auxiliary bus to the generator driven by the operating engine. A power card receives power from the auxiliary bus, converting the received power to a form compatible with the controller card and the memory card, and providing the converted power to the controller card and the memory card.

In general, any one or more of the operating statistics noted above, or any others known to those skilled in the art may be stored in the memory 224 and used by the controller 102 to determine which engine to start or shut down and/or how to control switch 230.

The controller described herein for executing instructions embodying methods of the present invention may be a computer, a dedicated computing device, a network of computing devices, or any other similar device.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

Having described aspects of the invention in detail, it will be apparent that modifications and variations are possible without departing from the scope of aspects of the invention as defined in the appended claims.

As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method of operating an off-highway vehicle having a plurality of engines, said method comprising:
storing operating statistics for each engine of the plurality of engines of the off-highway vehicle in a memory;
determining which of the plurality of engines are not running;
selecting an engine of the plurality of engines that is not running as a function of the operating statistics stored in the memory; and
starting the selected engine.

2. The method of claim 1 wherein the operating statistics stored in the memory comprise the total run time of each of the plurality of engines, and wherein selecting comprises selecting the engine of plurality of engines that is not running and has the lowest total run time.

3. The method of claim 1 further comprising associating an auxiliary power bus of the off-highway vehicle with the selected engine.

4. The method of claim 1 further comprising:
determining which of the plurality of engines are running;
selecting an engine of the plurality of engines that are running as a function of the operating statistics stored in the memory; and
shutting down the selected engine.

5. The method of claim 4 wherein:
storing operating statistics in the memory comprises storing the total run time of each of the plurality of engines; and
selecting comprises selecting the engine of plurality of engines that are running and has the highest total run time.

6. The method of claim 1 wherein storing operating statistics in the memory comprises storing at least one of:
miles traveled in forward by the off-highway vehicle;
miles traveled in reverse by the off-highway vehicle;
miles traveled in neutral by the off-highway vehicle;
kilowatt hours used for motive force by the off-highway vehicle;
total kilowatt hours produced by the off-highway vehicle;
maximum power developed in highest throttle position or rpm setting by the off-highway vehicle;
minimum power developed in highest throttle position or rpm setting by the locomotive;
hours and minutes that all engines of the locomotive were shut down;
hours and minutes that the locomotive has spent isolated;
total hours and minutes each engine has been shut down;
total hours and minutes each engine has been running;
hours and minutes each engine spent idling while the locomotive was parked;
hours and minutes each engine spent idling while the locomotive is setup in a direction and on-line (isolation switch placed in run);
hours and minutes each engine spent in each throttle position or rpm setting;
hours and minutes that the locomotive was unable to shutdown all of the engines due to a directional input being set to forward;
hours and minutes that the locomotive was unable to shutdown all of the engines due to a directional input being set to reverse;
hours and minutes that the locomotive was unable to shutdown all of the engines due to vehicle speed;
hours and minutes that the locomotive was unable to shutdown all of the engines due to battery charging current being greater than a predetermined battery charging current;
hours and minutes that the locomotive was unable to shutdown all of the engines due to battery voltage being below a predetermined battery voltage;
hours and minutes that the locomotive was unable to shutdown all of the engines due to ambient air temperature being too low;
number of times that the locomotive has started an engine due to a directional input being set to forward;
number of times that the locomotive has started an engine due to a directional input being set to reverse;
number of times that the locomotive has started an engine due to a brake cylinder pressure being below a predetermined brake cylinder pressure;
number of times that the locomotive has started an engine due to a battery voltage being below a predetermined battery voltage;
number of times that the locomotive has started an engine due to vehicle speed;
weighted average of the run time of each engine;
total revolutions of each engine;
estimated total revolutions of each engine; and
hours and minutes the compressor is pumping.

7. A method of operating an off-highway vehicle having a plurality of engines running, said method comprising:
storing operating statistics for each engine of the plurality of engines of the off-highway vehicle in a memory;
determining which of the plurality of engines are running;
selecting an engine of the plurality of engines that are running as a function of the operating statistics stored in the memory; and
shutting down the selected engine.

8. The method of claim 7 wherein the operating statistics stored in the memory comprise the total run time of each of the plurality of engines, and wherein selecting comprises selecting the engine of the plurality of engines that are running and has the highest total run time.

9. The method of claim 7 wherein the plurality of engines comprises a primary engine and a plurality of secondary engines wherein an auxiliary power bus receives power from the primary engine and provides power to auxiliary systems of the off-highway vehicle; and said selecting comprises selecting an engine of the secondary engines as a function of operating statistics stored in the memory.

10. The method of claim 9 wherein:
storing operating statistics a memory comprises storing the operating time of each of the plurality of engines; and
selecting an engine of the secondary engines comprises selecting the engine having the highest operating time.

11. The method of claim 7 wherein the off-highway vehicle has an auxiliary power bus for providing power from an engine of the plurality of engines to auxiliary systems of the off-highway vehicle and the selected engine is providing power to the auxiliary power bus, said method further comprising:
switching the auxiliary power bus from the selected engine to a second engine of the plurality of engines wherein the second engine is operating such that the auxiliary power bus receives power from the second engine.

12. The method of claim 7 wherein storing operating statistics in the memory comprises storing at least one of:
miles traveled in forward by the off-highway vehicle;
miles traveled in reverse by the off-highway vehicle;
miles traveled in neutral by the off-highway vehicle;
kilowatt hours used for motive force by the off-highway vehicle;
total kilowatt hours produced by the off-highway vehicle;
maximum power developed in highest throttle position or rpm setting by the off-highway vehicle;
minimum power developed in highest throttle position or rpm setting by the locomotive;
hours and minutes that all engines of the locomotive were shut down;
hours and minutes that the locomotive has spent isolated;
total hours and minutes each engine has been shut down;
total hours and minutes each engine has been running;
hours and minutes each engine spent idling while the locomotive was parked;
hours and minutes each engine spent idling while the locomotive is setup in a direction and on-line (isolation switch placed in run);
hours and minutes each engine spent in each throttle position or rpm setting;
hours and minutes that the locomotive was unable to shutdown all of the engines due to a directional input being set to forward;
hours and minutes that the locomotive was unable to shutdown all of the engines due to a directional input being set to reverse;
hours and minutes that the locomotive was unable to shutdown all of the engines due to vehicle speed;
hours and minutes that the locomotive was unable to shutdown all of the engines due to battery charging current being greater than a predetermined battery charging current;
hours and minutes that the locomotive was unable to shutdown all of the engines due to battery voltage being below a predetermined battery voltage;
hours and minutes that the locomotive was unable to shutdown all of the engines due to ambient air temperature being too low;
number of times that the locomotive has started an engine due to a directional input being set to forward;
number of times that the locomotive has started an engine due to a directional input being set to reverse;
number of times that the locomotive has started an engine due to a brake cylinder pressure being below a predetermined brake cylinder pressure;
number of times that the locomotive has started an engine due to a battery voltage being below a predetermined battery voltage;
number of times that the locomotive has started an engine due to vehicle speed;
weighted average of the run time of each engine;
total revolutions of each engine; and
estimated total revolutions of each engine.

13. A system for operating an off-highway vehicle having a plurality of engines, said system comprising:
a memory associated with the off-highway vehicle for storing operating statistics of the off-highway vehicle; and
a controller in communication with the memory for operating systems of the off-highway vehicle according to an application as a function of the operating statistics stored in the memory, wherein the memory is separate from the controller such that the controller can be replaced without replacing said memory so that the memory continues to be associated with the off-highway vehicle and maintains cumulative operating statistics of the off-highway vehicle independent of changes to the controller or application.

14. The system of claim 13 wherein the controller comprises a controller card and the memory comprises a memory card wherein said memory card is separate from said controller card.

15. The system of claim 14 wherein the controller card and the memory card communicate via a controller area network and/or a power card.

16. The system of claim 14 further comprising:
an auxiliary bus for receiving power from an engine of the plurality of engines and providing power to auxiliary systems of the off-highway vehicle;
a switch matrix controlled by the controller for selectively connecting the auxiliary bus to an engine of the plurality of engines according to the application in response to starting and shutting down engines of the off-highway vehicle; and
a power card for receiving power from the auxiliary bus, converting the received power to a form compatible with the controller card and the memory card, and providing the converted power to the controller card and the memory card.

17. The system of claim 13 wherein:
the operating statistics comprise the run time of each of the plurality of motors; and
the controller selects an engine of the plurality of engines to start as a function of the operating statistics stored in the memory by determining which engines of the plurality of engines are not running and selecting the engine of the plurality of engines that is not running and has the lowest run time.

18. The system of claim 13 wherein:
the operating statistics comprise the total run time of each of the plurality of engines; and
the controller selects an engine of the plurality of engines of the off-highway vehicle to shut down as a function of the operating statistics stored in the memory by determining which engines of the plurality of engines are running and selecting the engine of the plurality of engines that are running and has the highest total run time.

19. The system of claim 13 wherein the operating statistics stored in the memory comprise at least one of:
miles traveled in forward by the off-highway vehicle;
miles traveled in reverse by the off-highway vehicle;
miles traveled in neutral by the off-highway vehicle;
kilowatt hours used for motive force by the off-highway vehicle;
total kilowatt hours produced by the off-highway vehicle;
maximum power developed in highest throttle position or rpm setting by the off-highway vehicle;
minimum power developed in highest throttle position or rpm setting by the locomotive;
hours and minutes that all engines of the locomotive were shut down;
hours and minutes that the locomotive has spent isolated;
total hours and minutes each engine has been shut down;
total hours and minutes each engine has been running;
hours and minutes each engine spent idling while the locomotive was parked;
hours and minutes each engine spent idling while the locomotive was setup in a direction and on-line (isolation switch placed in run);
hours and minutes each engine spent in each throttle position or rpm setting;
hours and minutes that the locomotive was unable to shutdown all of the engines due to a directional input being set to forward;
hours and minutes that the locomotive was unable to shutdown all of the engines due to a directional input being set to reverse;
hours and minutes that the locomotive was unable to shutdown all of the engines due to vehicle speed;
hours and minutes that the locomotive was unable to shutdown all of the engines due to battery charging current being greater than a predetermined battery charging current;
hours and minutes that the locomotive was unable to shutdown all of the engines due to battery voltage being below a predetermined battery voltage;
hours and minutes that the locomotive was unable to shutdown all of the engines due to ambient air temperature being too low;
number of times that the locomotive has started an engine due to a directional input being set to forward;
number of times that the locomotive has started an engine due to a directional input being set to reverse;
number of times that the locomotive has started an engine due to a brake cylinder pressure being below a predetermined brake cylinder pressure;
number of times that the locomotive has started an engine due to a battery voltage being below a predetermined battery voltage;
number of times that the locomotive has started an engine due to vehicle speed;
weighted average of the run time of each engine;
total revolutions of each engine; and
estimated total revolutions of each engine.
